(19) United States
(12) Patent Application Publication
(10) Pub. No.: US 2005/0124210 A1
(43) Pub. Date: Jun. 9, 2005

(54) Electrcial connector with improved slider member

(76) Inventors: Chi Zhang, Kunsan (CN); BaoZeng Wang, Kunsan (CN); Xinlian Chen, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/991,884

(22) Filed: Nov. 17, 2004

(30) Foreign Application Priority Data
Nov. 19, 2003 (CN) 200320119823.3

(51) Int. Cl. H01R 12/24

(52) U.S. Cl. 439/495

(57) ABSTRACT

An electrical connector (100) is provided for connecting a flexible printed circuit or a flexible flat cable. The connector comprises a housing (1), a number of the electrical contacts (2) received in the housing and a slider member (3) movably mounted to the housing. The housing includes a mating surface (111) and a pair of arm receptacles (13). The slider member has a flat plate (30), a pressing portion (31) perpendicular to the plate and a pair of latching arms (32) extending from the plate. The plate defines a first opening (302) and a second opening (301). Each of the latching arms is wedge-shaped and has a latch (323) for engaging with the corresponding arm receptacles.

### BACKGROUND OF THE INVENTION

1. Field of the Invention

The present invention is generally related to the art of electrical connectors, and more particularly, to an electrical connector which is used to connect a flexible printed circuit or a flexible flat cable with a printed circuit board.

2. Description of Related Art

A variety of flexible printed circuit connectors are widely used in electronic devices such as mobile phones, keyboards and fax machines. These flexible printed circuit connectors are provided for connecting flexible printed circuits with printed circuit boards. A conventional flexible printed circuit connector generally comprises an insulated housing, a plurality of electrical contacts received in the housing and a slider member movably mounted to the housing. When a flexible printed circuit is mounted into the housing, the slider member presses the flexible printed circuit against the electrical contacts firmly to achieve a reliable electrical connection therebetween.

U.S. Pat. No. 6,371,797 discloses a flexible printed circuit connector. FIG. 1 of U.S. Pat. No. 6,371,797 shows that a housing of the flexible printed circuit connector comprises a pair of arm receptacles extending from lateral ends thereof. Each of the arm receptacles defines a slot therein. A slider member includes a plate and a pair of latching arms formed on lateral ends of the plate. When the flexible printed circuit is not mounted to the housing, an inserting mouth is provided between the slider member and the housing, so the latching arms can move around in the arm receptacles freely. After the flexible printed circuit is mounted to the housing, the slider member presses the flexible printed circuit against electrical contacts firmly. Accordingly, a complete electrical connection between the flexible printed circuit and the flexible printed circuit connector is established. However, with the trend toward miniaturization of electronic devices, the width of the latching arms is relatively small, and the latching arms are not adequately intense to endure the force applied thereon by repeatedly inserting into and pulling out of the housing. Therefore, the latching arms are easily damaged in operation or other applications especially in sections thereof at which the latching arms are connected with the plate.

Hence, an improved flexible printed circuit connector is highly desired to overcome the aforementioned disadvantages of the prior art.

### SUMMARY OF THE INVENTION

Accordingly, an object of the present invention is to provide a flexible printed circuit connector, which can provide adequate intensity to a slider member thereof.

In order to achieve the object set forth, an improved flexible printed circuit connector is provided. The flexible printed circuit connector comprises an insulated housing, a plurality of electrical contacts received in the housing and a slider member movably mounted to the housing. The housing comprises a mating surface and a pair of arm receptacles extending from lateral ends of the housing. The slider member comprises a flat plate, a pressing portion perpendicular to the flat plate and a pair of latching arms extending from lateral ends of the flat plate and lockable with the corresponding arm receptacles. Each of the latching arms is in wedge-shaped and has a latch at an end thereof for locking with corresponding arm receptacles.

Other objects, advantages and novel features of the present invention will be drawn from the following detailed description of a preferred embodiment of the present invention with attached drawings.

### BRIEF DESCRIPTION OF THE DRAWINGS

FIG. 1 is an assembled, perspective view of a flexible printed circuit connector in accordance with the present invention without a flexible printed circuit;

FIG. 2 is an exploded, perspective view of a housing and a slider member of the flexible printed circuit connector of FIG. 1;

FIG. 3 is a view similar to FIG. 2, but taken from another angle; and

FIG. 4 is a completely assembled, perspective view of the flexible printed circuit connector in accordance with the present invention.

### DETAILED DESCRIPTION OF THE INVENTION

Reference will now be made in detail to the preferred embodiment of the present invention.

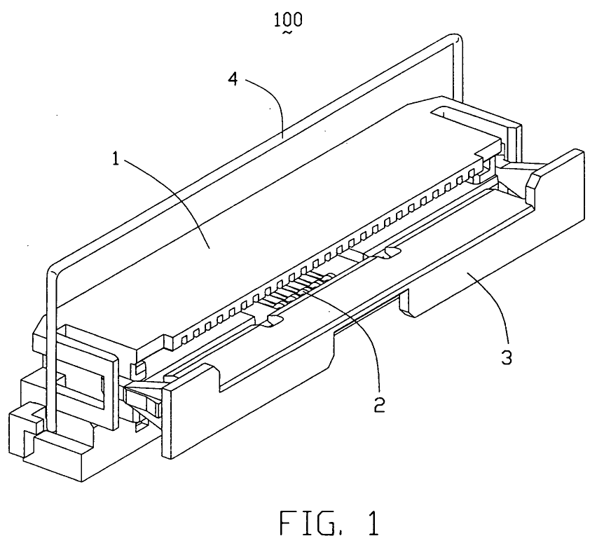

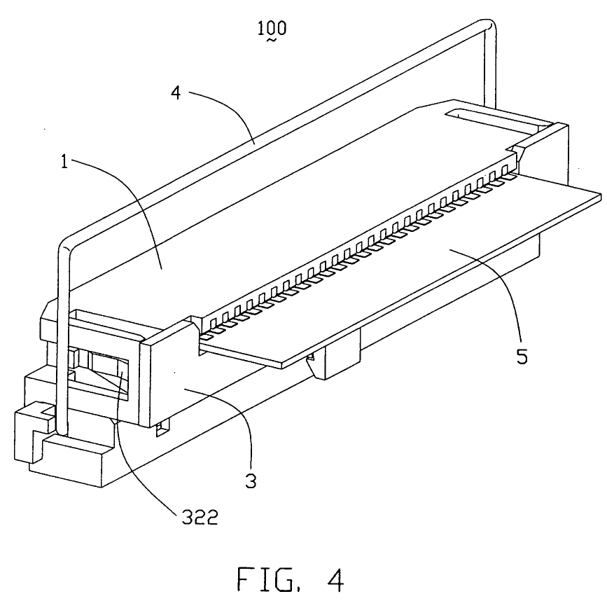

Referring to FIG. 1, an electrical connector 100 in accordance with the present invention comprises an insulated housing 1, a plurality of electrical contacts 2 received in the housing 1, a flexible printed circuit 5 (shown in FIG. 4), a slider member 3 movably mounted to the housing 1 and a pulling member 4.

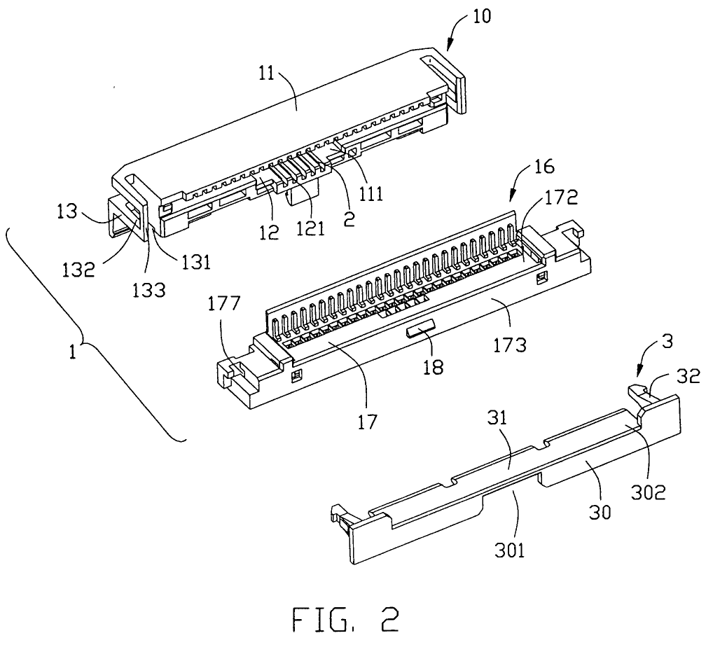

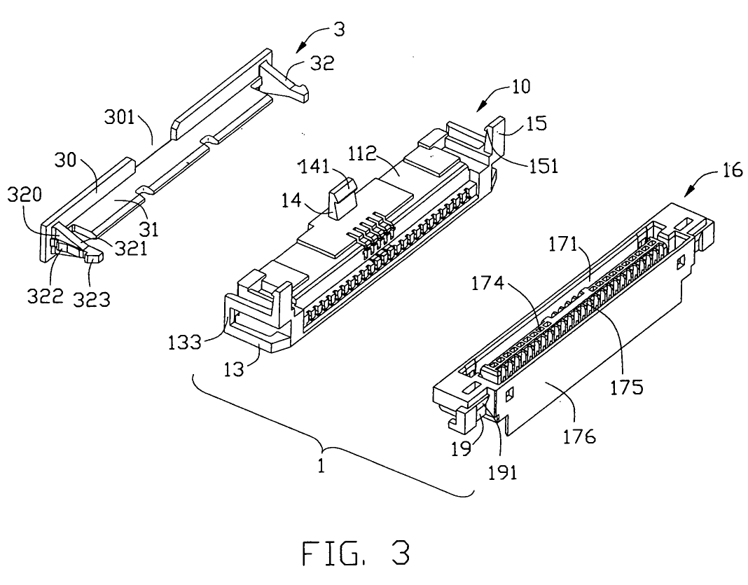

Referring to FIGS. 2 and 3, the insulated housing 1 comprises a first housing portion 10 and a second housing portion 16. The first housing portion 10 comprises a rectangular base portion 11 which includes a mating surface 111 extending along a longitudinal direction and a first mounting surface 112 adjoining the mating surface 111. A receiving space 12 is formed in the mating surface 111, and the upper and lower walls of the receiving space 12 respectively define a plurality of receiving channels 121 for securing the electrical contacts 2 therein. Moreover, the number of the receiving channels 121 is determined variably with the width of the flexible printed circuit 5. A pair of arm receptacles 13 are formed on lateral ends of the base portion 11 of the first housing portion 10. Each of the arm receptacles 13 extends outwardly and forwardly from lateral ends of a rear portion of the base portion 11 and is parallel to the receiving channels 121. A gap 131 is formed between the base portion 11 and each of the arm receptacles 13. Each of the arm receptacles 13 defines a slot 132 extending through one end thereof, and the other end of the arm receptacle 13 is served as a stop portion 133. A first latch portion 14 extends from the first mounting surface 112 and has a first latch 141. A pair of second latch portions 15 are opposite to the first latch portion 14 and extend from the first mounting surface 112. Each of the second latch portions 15 has a second latch 151.

The second housing portion 16 comprises a rectangular base 17 including a bottom surface 171, a second mounting surface 172 opposite to the bottom surface 171, a front surface 173 connecting the bottom surface 171 with the second mounting surface 172 and a rear surface 176 opposite to the front surface 173. A cavity (not labeled) is recessed from the bottom surface 171. A tongue portion 174 extends upwardly from the bottom of the cavity and defines a plurality of receiving grooves 175 at both sidewalls thereof for securing electrical contacts. The front surface 173 has a protrusion 18 for engaging with the first latch 141 of the first latch portion 14. A stop plate (not labeled) extends from the rear surface 176 and away from the bottom surface 171. A pair of recesses 19 are formed on a rear portion of the base 17 and are in communication with outer space. A rib 191 is formed on a surface of the recess 19 parallel to the rear surface 176 for locking with the corresponding second latch 151 of the second latch portion 15. The base 17 defines a retaining hole 177 respectively at lateral ends thereof for retaining the pulling member 4.

The slider member 3 has a flat plate 30, a pressing portion 31 extending from and perpendicular to the plate 30 and a pair of latching arms 32 formed on lateral ends of the plate 30 and extending along the same direction as the pressing portion 31. The plate 30 defines a first opening 302 and a second opening 301. The widths of the first opening 302 and the second opening 301 are respectively determined variably with the corresponding number and widths of the receiving channels 121 defined in the upper and lower sidewalls of the receiving space 12 of the first housing portion 10 for receiving a variety of the flexible printed circuits or flexible flat cables which have different widths. Each of the latching arms 32 comprises a sidewall 320 parallel to the pressing portion 31 and perpendicular to the plate 30, an inclined wall 321 adjacent to the sidewall 320, a projection 322 projecting from the sidewall 320 and a latch 323. The latching arms 32 are wedge-shaped, and a dimension of an end of each sidewall is larger than a dimension of the distal end of each sidewall. In such a way, the latching arms 32 are strong enough on one end thereof adjacent to the plate 30 to prevent it from breaking from the plate 30, while are slim enough at the distal end thereof to permit it move freely in the slots 132 and the gaps 131.

Referring to FIG. 1 in conjunction with FIG. 2 to FIG. 4, when not assembling the flexible printed circuit 5 into the electrical connector 100, the slider member 3 can move around in the gap 131 and the slot 132, that is, the slider member 3 is in an open position. Furthermore, the latches 323 of the latching arms 32 lock with the stop portion 133, so the latching arms 32 cannot break off the housing 1, meanwhile, an inserting mouth is formed between the housing I and a slider member 3.

Referring to FIG. 4 in conjunction with FIG. 2 and FIG. 3, the flexible printed circuit is mounted to the inserting mouth by zero insert force, then the slider member 3 is pressed into the receiving space 12 of the housing 1. When the projections 322 of the latching arms 32 lock with the stop portions 133 of the arm receptacles 13, the pressing portion 31 of the slider member 3 presses the flexible printed circuit 5 to connect with the electrical contacts 2 firmly, the slider member 3 is in a closed position. Consequently, a complete circuit is established between the flexible printed circuit 5 and the connector 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1.

2. The electrical connector as claimed in claim 1, wherein each of the latching arms comprises a sidewall perpendicular to the plate and a latch formed at a distal end thereof.

3. The electrical connector as claimed in claim 2, wherein a dimension of an end of each sidewall adjacent to the plate is larger than a dimension at the distal end of each sidewall.

4. The electrical connector as claimed in claim 2, wherein each of the arm receptacles of the housing defines a slot therein, and wherein the latches of the pair of latching arms are movable in the slots.

5. The electrical connector as claimed in claim 4, wherein the sidewall of the latching arm has a projection adjacent to the plate.

6. The electrical connector as claimed in claim 5, wherein each arm receptacle has a stop portion for engaging with the projection of each latching arm.

7. The electrical connector as claimed in claim 1, further comprising a pulling member, and wherein the housing defines a pair of retaining holes at the lateral ends thereof for retaining the pulling member.

8. The electrical connector as claimed in claim 1, wherein the pair of latching arms are perpendicular to the plate and are parallel to pressing portion.

9. The electrical connector as claimed in claim 1, wherein the housing comprises a first housing portion and a second housing portion.

10. The electrical connector as claimed in claim 9, wherein the first housing portion comprises a base portion having the mating surface and a first mounting surface, and a first latch portion formed on one side of the first mounting surface, and wherein the second housing portion comprises a second mounting surface, a bottom surface opposite to the second mounting surface, a front surface and a protrusion projecting from the front surface for engaging with the first latch portion.

11. The electrical connector as claimed in claim 10, wherein a pair of second latch portions are formed at lateral ends of the other side of the first mounting surface, and the second housing portion has a pair of ribs engaging with the pair of second latch portions.

12. The electrical connector as claimed in claim 10, wherein the second housing portion further comprises a rear surface and a stop plate extending from the rear surface and away from the second mounting surface.

13. The electrical connector as claimed in claim 1, wherein the mating surface is recessed into a receiving space, the upper and lower sidewalls of the receiving space defines a plurality of receiving channels for securing the electrical contacts therein.

14. The electrical connector as claimed in claim 1, wherein the plate further defines a first opening and a second opening.

15. An electrical connector for connecting a flexible printed circuit comprising:
a housing comprising a mating surface and a pair of arm receptacles at lateral ends thereof in a lateral direction;
a plurality of electrical contacts received in the housing; and
a slider member being movably mounted to the housing in a front-to-back direction perpendicular to said lateral direction, and comprising a plate, a pressing portion extending forwardly from the plate and a pair of latching arms extending forwardly from lateral ends of the plate, each of the latching arms defining a root portion joined with the plate; wherein
said root portion is enlarged in a vertical direction perpendicular to said front-to-back direction and said lateral direction.

16. The electrical connector as claimed in claim 15, wherein said latching arm defines a latch extending in the lateral direction.

17. The electrical connector as claimed in claim 15, wherein said arm receptacle is open in the vertical direction.

18. An electrical connector comprising:
a lower insulative housing;
a plurality of first contacts disposed in the lower housing;
an upper insulative housing;
a plurality of second contacts disposed in the upper housing;
the upper housing and the lower housing vertically assembled to each other with the first contacts mechanically and electrically engaged with the corresponding second contacts, respectively;
the lower housing defining a downward vertical mating port for receiving a complementary connector;
the upper housing defining a horizontal mating port for horizontally receiving a flexible printed circuit board; and
a slider member horizontally assembled into the mating port for electrically and mechanically connecting the flexible printed circuit board and the second contacts together.
